(19) United States
(12) Patent Application Publication
(10) Pub. No.: US 2026/0203025 A1
(43) Pub. Date: Jul. 16, 2026

(54) AI AGENT FOR SOFTWARE DEVELOPMENT AND CODING USING ARTIFICIAL INTELLIGENCE AND MACHINE LEARNING

(71) Applicant: REPLIT, INC., Foster City, CA (US)

(72) Inventors: Michele Catasta, San Mateo, CA (US); Zhen Li, Santa Clara, CA (US); James Austin, San Francisco, CA (US); Vaibhav Kumar, San Francisco, CA (US); Amjad Masad, Palo Alto, CA (US)

(21) Appl. No.: 19/021,417

(22) Filed: Jan. 15, 2025

(51) Int. Cl. G06F 8/35; G06F 8/60; G06F 11/362

(52) U.S. Cl. CPC G06F 8/35; G06F 8/60; G06F 11/362

(57) ABSTRACT

An AI-enabled agent generates computer code based on a natural language description and by injecting predefined code blueprints. The technique includes determining, based on a natural language code description for an unwritten computer program, application parameters. A predefined prompt is identified based on the application parameters and fused with the natural language code description. One or more predefined code portions for the application parameters are identified. A code generation model is invoked using the fused predefined prompt and natural language code description, and the one or more predefined code portions to obtain an initial build of a program. A series of additional coding actions are performed based on a set of coding actions for generating the computer code, during which user feedback is solicited and checkpoints are performed.

### BACKGROUND

Software development often requires developing or creating software programs in the form of computer code that can be very lengthy and complex. As such, creating and understanding a computer program can be difficult, particularly for novice programmers, or for programmers trying to use a mobile device for programming. Computer programmers write, modify, and test code and scripts that allow computer software and applications to function properly. Programming is a high value activity, for example, the U.S. Bureau of Labor Statistics projects programming jobs to grow over the coming decade, which also pay higher-than-average salaries. The median annual wage for computer and information technology jobs is typically about 50% higher than the median annual salary for all jobs.

While some tools exist to facilitate the creation of computer code, those tools often require a high level of understanding of programming. What is needed is an improved technique for providing tools for generating computer code that are more accessible to more users.

### BRIEF DESCRIPTION OF THE DRAWINGS

For a detailed description of various examples, reference will now be made to the accompanying drawings in which:

FIG. 1 shows an example network environment in which embodiments described herein may be performed, in accordance with one or more embodiments;

FIG. 2 shows a diagram of a technique for using an AI agent framework, in accordance with one or more embodiments;

FIG. 3 shows a flowchart of a technique for initiating an AI-enabled code generation process, according to one or more embodiments;

FIG. 4 shows a flowchart of an example technique for utilizing blueprints to intelligently generate computer code, in accordance with one or more embodiments;

FIG. 5 show a flowchart of a technique for refining an initial build from an AI-enabled code generation process, according to one or more embodiments; and

FIG. 6 shows an example network diagram in accordance with the disclosed embodiments.

### DETAILED DESCRIPTION

The present invention relates to an artificial intelligence (AI)-enabled agent that transforms natural language into computer code. More particularly, to an agent that interacts with a user through a chat interface, generates code based on user prompts and feedback, while leveraging predefined code segments and other tools to enhance and expedite the code generation process.

Techniques described herein improve upon traditional AI-enabled agents by providing an agent framework opportunistically incorporating human input into an automated process for program development. The result is a more efficient, user-friendly technique for computer-aided software development. The framework is configured to create software applications aligned with user requirements expressed in natural language.

According to some embodiments, the agent framework is provided in a cognitive architecture that takes as input a user request in natural language, and outputs either a refinement question or a software artifact. The agent framework may include or have access to a blueprint storage, in which blueprints, in the form of predefined code segments which can provide solutions for specific problems. Thus, the agent may parse the user request to determine a problem or action required, and perform a lookup to identify a corresponding blueprint to serve as a starting point for the code generation. In the process, the agent framework identifies checkpoints, where a state of the development should be captured, and points at which point user feedback is solicited. The user feedback may then be used to refine prompts used by the agent framework to generate computer code, and may also keep the user engaged in the development process. If necessary, the program can be returned to a state at the last checkpoint.

The agent framework described herein solves several technical problems inherent in traditional code generation systems. First, it reduces the likelihood of errors by quickly building an initial prototype based on a user's prompt, thus minimizing the number of iterative steps required. By training the agent to infer application requirements from the user prompt, a number of iterations can be reduced, thereby reducing time, power, and compute required to build computer code. Each step in a traditional system carries a probability of error, and by reducing the number of iterations, the agent framework increases the overall reliability of the code generation process. Additionally, the use of predefined code portions, or blueprints, allows the agent to inject reliable, pre-tested code into the project, further enhancing the quality and reducing the time and resources required for development.

In the following description, numerous specific details are set forth to provide a thorough understanding of the various techniques. As part of this description, some of the drawings represent structures and devices in block diagram form. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components. It should be understood that the language used in this disclosure has been principally selected for readability and instructional purposes, and may not have been selected to delineate or circumscribe the disclosed subject matter. As such, the various processes may be performed by alternate components than the ones described.

Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

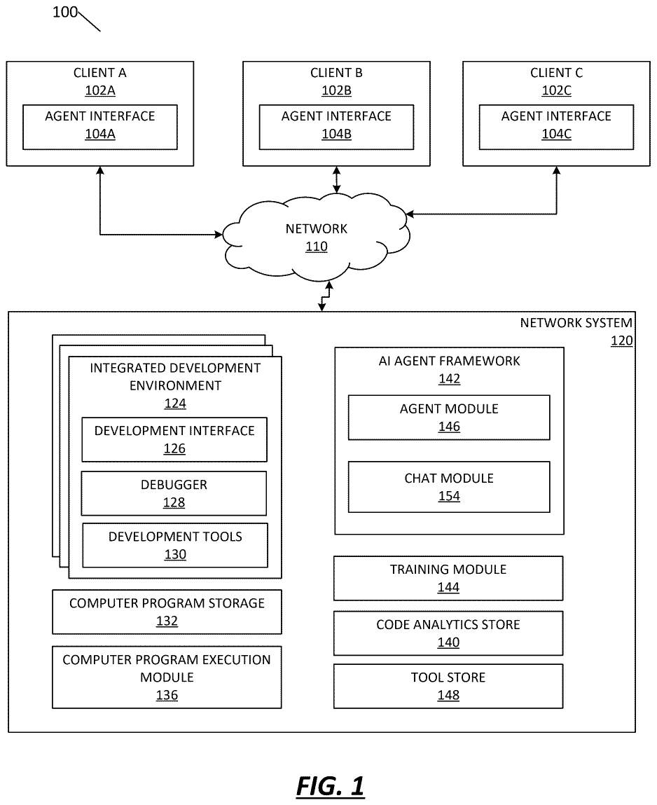

FIG. 1 shows a network diagram of an environment 100 in which various embodiments described herein may be practiced. Techniques described herein provide a system and method for incorporating an AI-driven agent for developing computer code within an integrated development environment. The network diagram includes multiple client devices, such as client A 102A, client B 102B, and client C 102C, communicably connected to a network system 120 across a network 110. Although a particular representation of components and modules is presented, it should be understood that in some embodiments, the various components and modules may be differently distributed among the devices pictured, or across additional devices not shown.

Clients 102A, 102B, and 102C may each be computing devices from which an instance of an agent interface is accessed. According to one or more embodiments, the agent interface may be part of an integrated development environment (IDE), or may be a separate application. An IDE is computer software that provides tools used by programmers to develop software. The IDE may include, for example, a source code editor, code package manager, debugger, and other programming tools. The IDE 124 may be hosted on one or more network devices of network system 120. The IDE 124 may be accessed across the network 110 via an IDE interface from each client, and/or by an AI-enabled agent. The IDE interface may be an application running on the corresponding client device, or may be accessed from a remote device such as a network device via a web browser, or the like. The agent may act as an interface by which a user at a client device can direct a computer to use the components of a development environment to perform computer code development tasks. Thus, client A 102A includes agent interface 104A. Client B 102B includes agent interface 104B. Finally, client C 102C includes agent interface 104C. Each of the agent interfaces may be a locally stored application on the corresponding client device, or may be accessed remotely from a network system 120.

As shown, network system 120 is accessible by client device A 102A, client device B 102B, and client device C 102C across network 110. Network system 120 hosts IDE 124. The IDE 124 may include a development interface 126, which may provide a source code editor for a computer program which is the focus of a development session by one or more programmers on the client devices 102A, 102B, and 102C, either by directly interfacing with the development interface 126, or by way of an agent through the agent interface 104. The IDE 124 may additionally include a debugger 128. Debugger 128 is a program that facilitates the detection and correction of errors in other computer programs. In addition, the debugger can be used as a tool to track the operation of other computer programs. To that end, the debugger 128 may be a program which provides a capability to monitor the execution of a program, stop the program, start the program, set breakpoints, set and read values, and the like. The debugger 128 includes logic such that it is capable of communicating with the operation system to cause the program to perform debugging actions, such as pause, continue, modify, inspect memory, and the like.

According to some embodiments, the IDE 124 may include development tools 130. The development tools 130 may include programming modules or processes which can be used to enhance code development. For example, the development tools 130 may include an interface to other tools, such as the AI agent framework 142. The AI agent framework 142 may include a chat module 154, which uses one or more language models to interact with users of the client devices 102A, 102B, 102C. For example, the chat module 154 may receive natural language code descriptions or requests from the users. The chat module 154 may parse the natural language input to provide the agent module 146 with information about the parameters for the requested program. In addition, the chat module 154 may generate prompts for user response based on actions directed by the agent module 146.

The agent module 146 may implement the core functionality and behavior of the AI agent framework 142. The AI agent module 146 may act as a connective component between the IDE 124 and other tools and resources which are used to create computer code. The agent module 146 may further interact with the computer program execution module 136 and the code analytics store 140 to obtain the results of the execution and the data and the analysis results related to the computer programs, or portions of computer programs. In some embodiments, the agent module 146 may access tool store 148, which may store one or more blueprints in the form of predefined code portions or code segments which may act as a starting point for the AI agent framework 142. The tool store 148 may include predefined code segments, such as code templates, code snippets, code patterns, or the like. In addition, the tool store 148 may include tools that allow the agent to execute computer code to test functionality and ensure that the generated code works as intended. This may include code libraries, code frameworks, or computing functions that are predefined either by human developers, or generated by a generative model. The predefined code portions may be related to various application parameters, such as application domains, application features, application components, application stacks, application platforms, application languages, application libraries, application frameworks, or any other application parameters.

The developed code may be stored, for example, in computer program store 132. This computer program storage 132 may be a storage space provided on a per account basis. For example, an account may be associated with an individual developer (e.g., user) developing the computer program, or the account may be an organizational account associated with an organization, such as a company, corporation, etc., with multiple developers'(e.g., users') sub-accounts associated with the organizational account developing the computer program. In some cases, multiple computer programs may be associated with a single account. Code specific for the computer program, along with other data for the computer program (e.g., images, data files, etc.), may be stored in the computer program storage 132, and the computer program storage 132 may be allotted a certain amount of available storage, for example, based on a status, service tier, type, etc. of the account. In some cases, the computer program storage 132 may be a part of a container, such as a docker container, or part of a virtual machine image. The computer program storage 132 may also be hosted, for example, on a cloud service, such as Google Cloud Platform (Google is a registered trademark of Google LLC), Amazon Web Services (Amazon Web Services is a registered trademark of Amazon Technologies, Inc.), etc. The computer program may be written in any known computer programming language.

According to one or more embodiments, the AI agent framework 142 may include or have access to one or more trained networks configured to generate computer code, or content that is related to computer code, such as language models or the like. Thus, network system 120 includes a training module 144, which may train one or more networks using the data and the analysis results from computer program storage 132, and/or the code analytics store 136. Code analytics store 140 can include, for example, source code entered by a user as well as other code entry data, such as, cursor movements, and other usage information within the IDE 124 during development of computer code. Other examples include time stamps for code entry and edits, file creation times, additions and deletions of text, use of development tools provided by the IDE, interaction with APIs or other infrastructure available to the user/program, and the like. As such, the code analytics store 140 may collect usage data derived from multiple users and multiple devices, such as client A 102A, client B 102B, and client C 102C. Accordingly, the models may be trained to infer particular application types and application parameters most commonly built based on the training data.

The training module 144 may use any AI models, algorithms, or technologies, such as deep neural networks, recurrent neural networks, convolutional neural networks, transformers, generative adversarial networks, reinforcement learning, supervised learning, unsupervised learning, or any other AI models, algorithms, or technologies. Further, the one or more networks may be trained to provide predictive output, generative output, classification output, or some combination thereof. The training module 144 may update the trained networks periodically or dynamically.

The AI agent and various AI tools may utilize artificial intelligence to assist programmers in creating computer code. In doing so, the AI agent and various AI tools may provide, at least in part, a form of generative AI in which the system uses user input to create new content. In particular, the various tools may utilize machine learning algorithms trained to perform various programming tasks. Further, in some embodiments, one or more of the various tools may be trained or tuned based on a particular user's code activities, thereby creating custom models for individual users. As another example, a particular network may be tuned based on a particular user's code activities, for example in a post-processing manner, such that the output of the model may be refined for a particular user. In some embodiments, the IDE 124 is configured to store operational transformation edits, from which natural cursor movements and entry of text from human programmers in the code edits can be identified.

In addition to training each of the networks, additional steps may be taken to fine tune the models. For example, in some embodiments, the training data may be weighted based on age such that the most recent data is most heavily weighted during the training. Other heuristic filters can be applied to discard, truncate, or otherwise transform proposed code segments. Examples include consideration of a user's prior written code, a cost to a platform to pull code segments and display to the user, a probability that the proposed code will be acceptable to the user, and the like. Additional fine tuning of the models may result in lower latency when responding to the user with a proposed code suggestion. The models may be fine-tuned, for example, with additional code such that new examples can be learned relevant to a particular domain and use. For example, the models may be fine-tuned for a particular team's code such that the models generate code and other content in a manner more relevant to the team. Additional fine tuning of the models may also result in more accurate or desirable proposed code suggestions for the user.

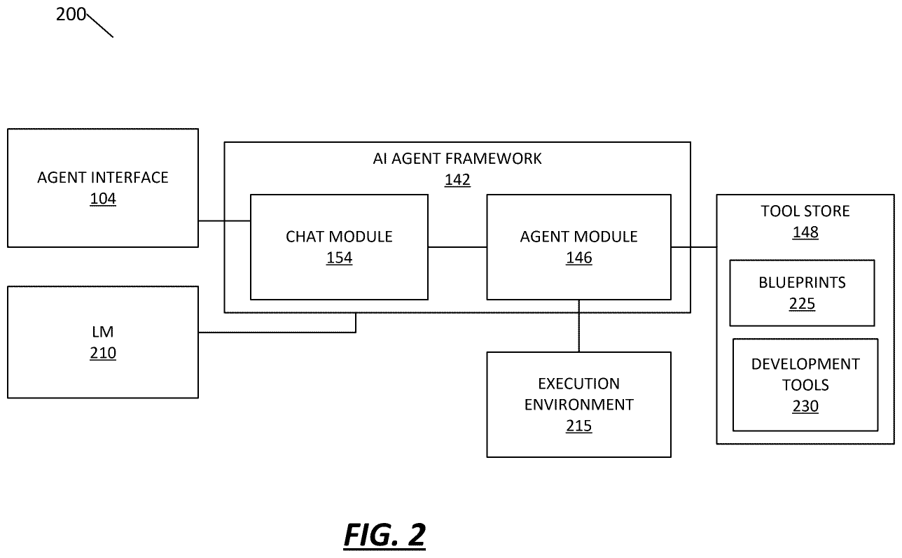

FIG. 2 shows a diagram of a technique for using an AI agent framework 142, in accordance with one or more embodiments. In particular, FIG. 2 illustrates a flow diagram 200 among the AI agent framework 142 and other various components used to generate computer code. The various components depicted are for illustrative purposes, and it should be understood that alternative components or additional components may be utilized according to some embodiments. Further, the functionality of the various components may be differently distributed, in accordance with one or more embodiments.

The diagram begins with a user providing an input in agent interface 104 for software development and coding using the AI agent framework 142, according to one or more embodiments of the invention. The agent interface 104 may interface with the development interface 124 via the agent framework 142. Accordingly, agent interface 104 may provide one or more interfaces through which a user may enter code generation prompts, receive feedback, view code, perform additional coding actions, or the like.

According to one or more embodiments, the user provides a natural language prompt to the AI agent framework 142 via the agent interface 104. The agent interface 104 may be configured with a chat interface by which a user can provide prompts and answers to a chat module 154 of the agent framework 142. The agent interface 104 may therefore be configured to receive natural language descriptions of unwritten computer code (i.e., the “target” computer program). Said another way, a user may provide the AI agent framework 142 with a description of a target functionality of an unwritten computer program in the form of an intended code generation request. In some embodiments, the AI agent framework 142 may be configured to ingest other user-provided data, such as contextual information for the computer program, information regarding the design, look, and feel of the computer program, or the like. According to some embodiments, the chat module 154 may be configured to interface with a user to receive natural language prompts, provide feedback, ask follow-up questions or the like. To that end, the chat module 154 may be powered by one or more language model 210. The language model 210 may include one or more generative models which are trained to process natural language input and provide a natural language response, a response in the form of a code segment, code prompt, or the like. In some embodiments, one or more models may be specifically trained for program development, for interaction with the AI agent framework 142, or the like. In some embodiments, the chat module 154 and the agent module 146 may use a same or different language model 210. Further, language model 210 may be comprised of multiple language models used for the same or different purposes.

According to one or more embodiments, the AI agent framework 142 utilizes a technique that interleaves reasoning and acting steps, and opportunistically prompts a user for feedback to refine performance of the AI agent, and to maintain user engagement. Accordingly, the chat module 154 may interface with the agent module 146 such that the agent module 146 may automatically perform computer programming tasks based on data passed from the chat module 154. The agent module 146, which may implement the core functionality and behavior of the AI agent 142, as described above. The agent module 146 may receive the natural language code description or request from the chat input, and determine, based on the code description or request, application parameters for the target computer program. The application parameters may include, for example, the application domain, the application features, the application components, the application stack, the application platform, language or library information, or any other application parameters. The agent module 146 may also identify predefined tools from tool store 148 which can be used for the determined application parameters. Predefined tools may include, for example, blueprints 225 in the form of predefined code segments that correspond to the determined parameters. In addition, predefined tools may include development tools 230 that allow the agent to execute computer code to test functionality and ensure that the generated code works as intended. This may include code libraries, code frameworks, or computing functions that are predefined either by human developers, or generated by one or more generative AI models.

According to one or more embodiments, the agent module 146 may then fuse the determined application parameters, and include any identified predefined tools as a context for the prompt. The agent module 146 may use the fused user input and context as a prompt to invoke one or more language models from LM 210 to generate computer code satisfying the determined application parameters. In doing so, the LM 210 may generate computer code for the agent module 146. The agent module 146 may then execute the generated computer code in the execution environment 215. The execution environment 215 may be a container configured to execute computer code. In some embodiments, the execution environment may return an output result of the computer code, debugging results, or the like.

In some embodiments, the agent module 146 may be configured to collect a result of the computer code, such as a portion of the computer code, and test the computer code prior to providing it back to a user. For example, the agent module 146 may perform a debugging operation on the computer code, inspect an output of the computer code, or the like. According to one or more embodiments, a determination may be made at the agent module 146 that additional user input is needed. This may be based on a predefined user feedback step in a programming plan, or based on actions or results at the agent module 146 while performing the programming plan. The agent module 146 may then pass the state of the program as provided by the agent module 146 and generate a prompt for user feedback. For example, the chat module 154 may generate a user prompt for additional context regarding the requested application, and/or for confirmation that the computer code is performing as expected. As an example, the chat module 154 may request user confirmation that a preview of the target application appears or functions as expected based on actions performed by the agent module 146.

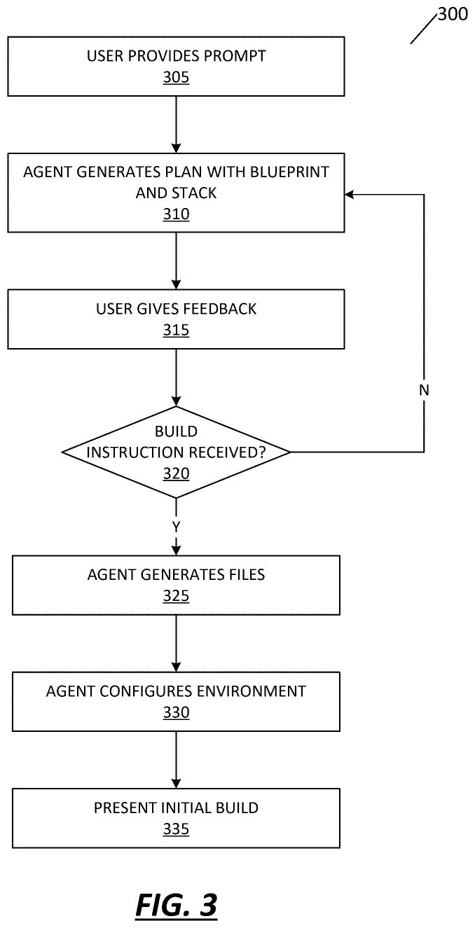

FIG. 3 shows a flowchart of a technique for initiating an AI-enabled code generation process, according to one or more embodiments. In particular, FIG. 3 shows a flowchart of a technique for generating an initial build of a target computer program, in accordance with one or more embodiments. It should be understood that the particular flow of the flow diagram is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components for purposes of explanation, but should not be considered limited to those components.

The flowchart 300 begins at block 305, where a natural language code description is received from a user. In some embodiments, the natural language code description may be received in a text input component within a development interface. The natural language code description may indicate a target functionality of yet-to-be-written computer code for a target computer program. According to one or more embodiments, the user provides the prompt to a chat module, which is configured to interpret the input text into target actions for the agent module. In some embodiments, the natural language code description may infer unspecified characteristics based on training data. For example, the chat module may be trained based on computer code written by a user base such that inferences can be made about the type of program the user is attempting to generate.

At step 310, the agent module generates a programming plan using one or more blueprints or other predefined tools. As described above, the agent module may receive the application parameters from the chat module. Alternatively, the agent module may be configured to determine the application parameters from the user input in the chat module. The plan may include a series of steps that the agent will take to generate the requested computer code. The set of coding actions may include, for example, creating a new file, importing a library, defining a function, calling a function, assigning a variable, writing a statement, writing a condition, writing a loop, writing a comment, or any other coding actions. In addition, the agent module may perform a search or other lookup for available blueprints or other predefined tools that are candidates for the code generation. In some embodiments, the plan may include one or more checkpoints, at which point a state of the target program will be stored such that the programming actions performed can be rolled back to a prior checkpoint. Further, the plan may include one or more user feedback triggers at which a user should be solicited for feedback about how the agent is performing.

In some embodiments, the steps of the plan may be presented iteratively to a user and, optionally, in association with a feedback prompt for the user. For example, at block 315, the agent may engage the user in the development process such that the user is presented with information in natural language about the steps to be performed and/or blueprints to be used. The user can optionally confirm or refine the steps to be taken to better direct the code development. Additionally, or alternatively, information related to the development of the programming plan may be presented or made available to the user. For example, information related to steps performed by the agent may be provided or presented in an agent interface, which may be presented within, or along with, a chat interface. Feedback may be received by the user, for example, in the form a confirmation of the programming plan in the form of a build instruction, or additional input for adjusting the programming plan.

A determination is made at block 320 as to whether the build instruction is received. For example, a determination may be made as to whether user input is received confirming the programming plan. If a build instruction is not received, then the flowchart 300 returns to block 310, and the agent adjusts the programming plan based on the user feedback from block 315.

Returning to block 320, once the build instruction is received, then the flowchart 300 proceeds to block 325, where the agent proceeds to generate the files. According to one or more embodiments, the agent module may generate a prompt and additional context from the application parameters, as well as the blueprints and/or other available tools. The agent module may then pass the prompt and context to a language model configured to generate computer code. In some embodiments, the language model may be configured to prioritize the blueprints such that the language model treats the blueprint as a template in generating computer code to satisfy the application parameters.

The flowchart 300 proceeds to block 330, where the agent module configures an execution environment based on the generated code. The environment configuration may include, for example, the execution environment, the development tools, the code libraries, the code frameworks, the code dependencies, the code settings, the code variables, or any other environment configuration in accordance with the generated files. In some embodiments, this may include predefined tools used by the agent for performing code development activities.

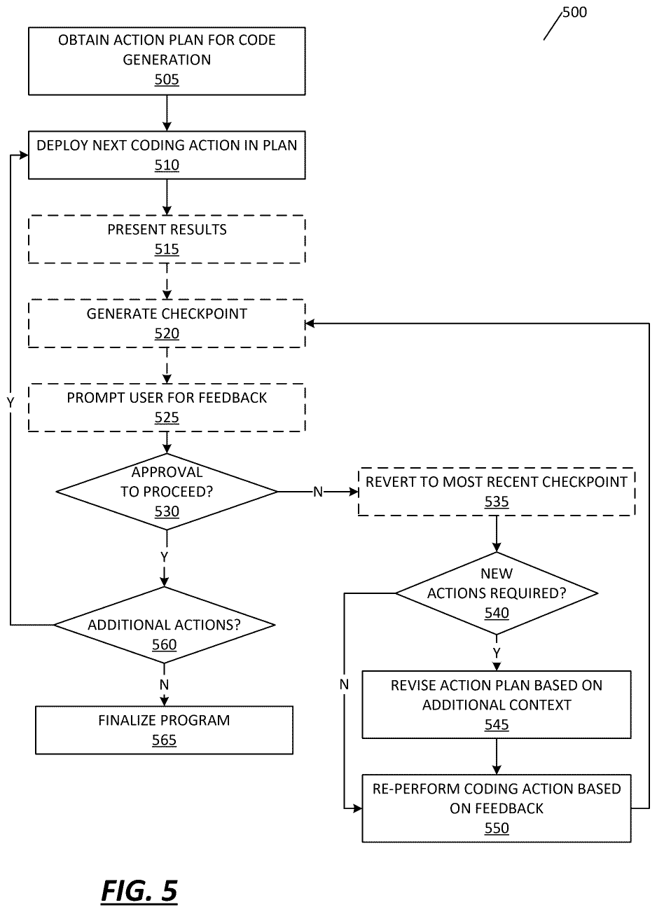

The flowchart 300 concludes at block 335, where an initial build of the target program is provided. In some embodiments, the initial build, and/or an executed version of the initial build may be presented to a user for additional user feedback, for example as a preview of the initial build. In doing so, the agent may generate the initial build with limited user input such that a user can quickly see a version of the target application. Accordingly, the agent may be configured to infer user intent for the target application, for example based on training data comprised of preexisting applications generated to perform particular tasks. Thus, the initial build is considered a first draft of the target application, and can serve to set the stage for the more interactive development process with the user. In some embodiments, the initial build may include all the intended functionality for the application, or a portion of the intended functionality. For example, the initial build may comprise a shell application which is executable to perform parts of the functionality requested so that the user has a draft application to review. Then, an iterative process involving more user feedback may be performed to refine the application and add the remaining functionality, as will be described in greater detail below with respect to FIG. 5. Accordingly, the initial build may provide a fully functional application.

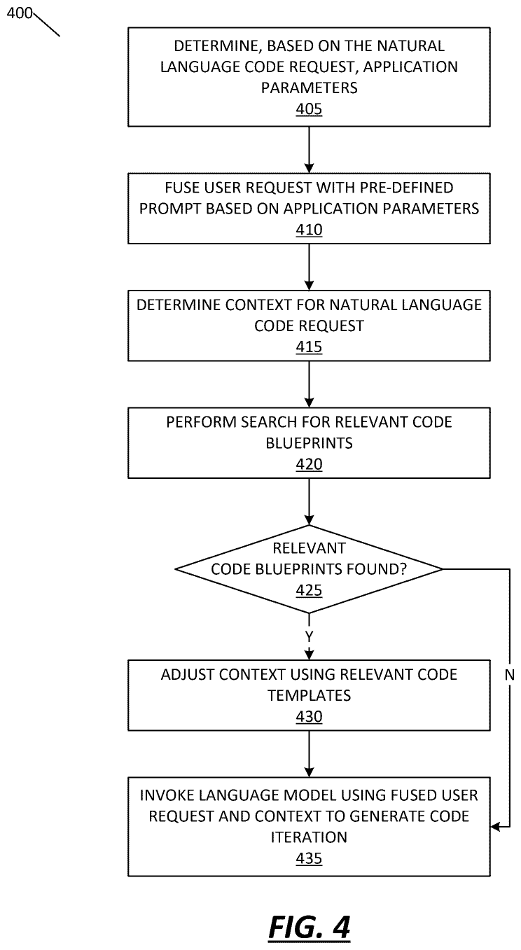

As described above, the initial build can be generated by an agent module invoking a language model to generate computer code. FIG. 4 illustrates a flowchart 400 of a technique for generating computer code using blueprints and other predefined tools, according to an embodiment of the invention. It should be understood that the particular flow of the flow diagram is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components for purposes of explanation, but should not be considered limited to those components.

The flowchart 400 begins at block 405, where the agent framework determines, based on the natural language intended code generation request, application parameters. The application parameters may include, for example, the application domain, the application features, the application components, the application stack, the application platform, the application language, the application library, the application framework, or any other application parameters. In some embodiments, the agent framework may determine a user intent for the target application based on user input and/or predefined configurations of the agent framework.

At step 410, the agent framework may fuse the user request with a pre-defined prompt based on the application parameters. The pre-defined prompt may include, for example, a description of the coding actions, a target functionality, and/or other information to generate the unwritten computer program. In some embodiments, the agent may select from a set of pre-defined prompts based on inferences related to the user intent for the target program. For example, the agent may have access to a library of predefined prompts corresponding to frequent user requests. In doing so, the agent may quickly generate an initial build of an application for presentation to a user, which can then be refined, as described below with respect to FIG. 5. According to one or more embodiments, fusing the user request with the pre-defined prompt may include concatenating or combining the user request with a pre-defined prompt, and/or generating a combination of the user request with the pre-defined prompt using weighted values or other parameters to generate a fused input.

The flowchart 400 continues to block 415, where a context is determined for the natural language code request. The context may include, for example, one or more types of functionality that should be performed, tools needed to perform the programming functions, or the like. Thus, at block 420, the agent may perform a search for relevant code blueprints based on the context, or other predefined tools or functionality which can be used to generate the computer code requested. If, at block 425, a relevant code blueprint is found, then the flowchart 400 proceeds to block 430.

At block 430, the agent module may adjust the context using the relevant code blueprints or other predefined functions or data. In particular, the agent module may adjust the context to be passed to the language model along with the application parameters to include the relevant code blueprints. In doing so, the language model can more efficiently generate computer code based on the blueprints.

After the context is adjusted at block 430, or if no relevant code blueprints are found at block 425, the flowchart 400 concludes at block 435. At block 435, a language model is invoked using the fused input from block 410 and the context. The language model may be a specialized model to generate computer code, or may be a language model more generally trained on natural language. The language model may include one or more generative AI models which are configured to generate new content based on an input and training data on which the model was configured. As a result, the language model may generate computer code in line with the agent request.

According to some embodiments, once the code is generated, the agent may perform a debugging to ensure the code is working as intended, execute the code to ensure the output is as intended for the like. The agent can then revise the code by way of the language model without user input in order to provide an initial build of the target application that is functional for presenting as a preview to the user.

Once the program plan is initiated, an iterative process is performed in which the agent builds the target application. During the process, the agent opportunistically seeks user feedback related to the application. The user feedback allows the agent to refine the programming plan, and keep the user engaged in the development process. FIG. 5 shows a technique for performing a program action plan, in accordance with one or more embodiments. It should be understood that the particular flow of the flow diagram is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components for purposes of explanation, but should not be considered limited to those components.

The flowchart 500 begins at block 505, the agent module 146 obtains an action plan for code generation. The action plan may be a series of steps or other actions that are determined to be required to generate the requested computer code to satisfy the application parameters from the user input. At block 510, a next coding action in the plan is deployed by the agent. This may include for example, creating a new file, importing a library, defining a function, calling a function, assigning a variable, writing a statement, writing a condition, writing a loop, writing a comment, or any other coding actions.

The flowchart 500 proceeds to block 515, where the agent framework optionally presents, or provides for presentation, a result of the coding action. The result may include, for example, an executed version of the program and/or computer code generated, or a description of the computer code generated. In some embodiments, the agent may iterate through multiple coding actions prior to presenting the results. Alternatively, the agent mya present information related to the actions being performed, but may only present an executed version of the generated code at certain points in the plan where user feedback is needed.

At block 515, a checkpoint is optionally generated for a state of the generated code. In some embodiments, a checkpoint may be generated prior to each user feedback request. Further, checkpoints may be included at other points in the action plan, for example at points in the development process which may be useful to roll back to for refining the target application.

At block 525, a user is optionally prompted for user feedback. The user feedback checks may include, for example, points in the set of coding actions where the chat module may prompt the user for feedback, such as a question, a feedback request, a confirmation, or any other user feedback checkpoint based on progress of the code generation to that point in the plan. The user feedback checkpoints may be determined based on the complexity, the ambiguity, the uncertainty, the preference, or any other criteria of the set of coding actions. As another example, the user feedback checks may be selected at predefined points to maintain user engagement. In some embodiments, the prompt may be generated based on a current state of the computer code, prior user input, or the like. Thus, the user prompt may be generated by a generative AI model, such as a language model, configured to prepare user prompts related to the computer code being generated.

The flowchart proceeds to block 530, where a determination is made as to whether the agent has approval to proceed. This may occur, for example, if the agent performs a check on the code developed based on the coding action from block 510. Thus, the determination may include determining that the code has been generated and performed as expected. As another example, if a user was prompted for feedback, the determination may be based on a user response, for example if a user confirms that the output of the application is performing as expected.

If approval is not confirmed, then the flowchart proceeds to optional block 535, where the program is reverted to a state as saved at the most recent checkpoint, such as a checkpoint prior to the most recent coding action in the plan. For example, if a user indicates that the application is not performing as expected, then the computer code can be rolled back prior to the last time the user confirmed the application output. As another example, the roll back may be performed based on a particular component or functionality of the computer code at the subject of the user feedback.

A determination is made at block 540 if new actions are required. This may occur, for example, if the action plan should be revised based on the user input, or a determination by the agent based on the performance or output of the computer code. If new actions are required, then the flowchart proceeds to block 545, and the action plan is revised by the agent based on additional context received from the user input. This may occur, for example, by determining a revised set of programming actions based on the user input, which may include adding new actions, changing one or more pre-existing actions, or the like.

The flowchart proceeds to block 550, where the coding action is re-performed based on the feedback. For example, the agent may use the additional information from the user input to identify new tools or blueprints, or generate new prompts which can then be provided to a language model configured to generate computer code. As an example, the agent may perform one or more steps as described above with respect to FIG. 4. Returning to FIG. 5, the flowchart then returns to block 520 where, optionally, a checkpoint is generated. Then, at block 525, the user can be prompted to determine where the revised computer code satisfies the user's intent.

If, at block 530, approval is confirmed, then the flowchart proceeds to block 560 and a determination is made as to whether additional actions are available in the action plan. If not, the flowchart 500 concludes at block 565, and the code is finalized. In some embodiments, finalizing the code may involve finalizing the program for the user. In some embodiments, finalizing the code may involve finalizing the program for the user.

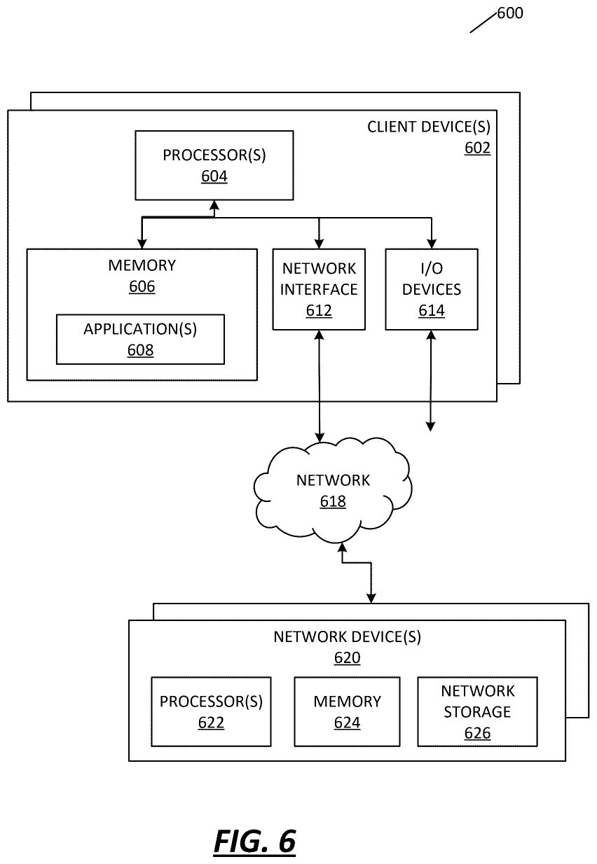

FIG. 6 shows an example of a hardware system for implementation of the AI agent in accordance with the disclosed embodiments. FIG. 6 depicts a network diagram 600 including a client computing device 602 connected to one or more network devices 620 over a network 618. Client device 602 may comprise a personal computer, a tablet device, a smart phone, network device, or any other electronic device which may be used to perform debugging operations on a computer program. The network 618 may comprise one or more wired or wireless networks, wide area networks, local area networks, enterprise networks, short range networks, and the like. The client computing device 602 can communicate with the one or more network devices 620 using various communication-based technologies, such as Wi-Fi, Bluetooth, cable connections, satellite, and the like. Users of the client devices 602 can interact with the network devices 620 to access services controlled and/or provided by the network devices 620.

Client devices 602 may include one or more processors 604. Processor 604 may include multiple processors of the same or different type, and may be configured to execute computer code or computer instructions, for example computer readable code stored within memory 606. For example, the one or more processors 604 may include one or more of a central processing unit (CPU), graphics processing unit (GPU), or other specialized processing hardware. In addition, each of the one or more processors may include one or more processing cores. Client devices 602 may also include a memory 606. Memory 606 may each include one or more different types of memory, which may be used for performing functions in conjunction with processor 604. In addition, memory 606 can include one or more of transitory and/or non-transitory computer readable media. For example, memory 606 may include cache, ROM, RAM, or any kind of computer readable storage device capable of storing computer readable code. Memory 606 may store various programming modules and applications 608 for execution by processor 604. Examples of memory 606 include magnetic disks, optical media such as CD-ROMs and digital video disks (DVDs), or semiconductor memory devices.

Computing device 602 also includes a network interface 612 and I/O devices 614. The network interface 612 may be configured to allow data to be exchanged between computing devices 602 and/or other devices coupled across the network 618. The network interface 612 may support communication via wired or wireless data networks. Input/output devices 614 may include one or more display devices, keyboards, keypads, touchpads, mice, scanning devices, voice or optical recognition devices, or any other devices suitable for entering or retrieving data by one or more client devices 602.

Network devices 620 may include similar components and functionality as those described in client devices 602. Network devices 620 may include, for example, one or more servers, network storage devices, additional client devices, and the like. Specifically, network device may include a memory 624, network storage 626, and/or one or more processors 622. The one or more processors 622 can include, for example, one or more of a central processing unit (CPU), graphics processing unit (GPU), or other specialized processing hardware. In addition, each of the one or more processors 622 may include one or more processing cores. Each of memory 624 and network storage 626 may include one or more of transitory and/or non-transitory computer readable media, such as magnetic disks, optical media such as CD-ROMs and digital video disks (DVDs), or semiconductor memory devices. While the various components are presented in a particular configuration across the various systems, it should be understood that the various modules and components may be differently distributed across the network.

According to some embodiments, limited user information may be used to perform techniques described herein. For example, user-generated content, user input, keystrokes, computer code, and the like may be tracked and used as training data for AI tools described herein. Other electronic tools may be used to collect information such as cookies, pixel tags, and similar technologies. It should be understood that the privacy of individuals who use the IDE and the AI tools described herein is protected under relevant privacy policies. In some embodiments, user information may be collected upon agreement of the end user to participate in such efforts in accordance with the relevant privacy policies.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

1. A non-transitory computer readable medium comprising computer readable code executable by one or more processors to:
determine, based on a natural language code description for an unwritten computer program, application parameters;
identify one or more predefined development tools for the application parameters from a tool store, wherein the one or more predefined development tools comprises one or more predefined code segments; and
invoke a language model to generate an initial build of program code for the unwritten computer program based on the application parameters and the one or more predefined code segments.

2. The non-transitory computer readable medium of claim 1, further comprising computer readable code to:
determine, based on the natural language code description, an intended code generation request;
determine a set of coding actions to generate the unwritten computer program based on the intended code generation request; and
present a description of the set of coding actions and a first user prompt for user approval,
wherein the language model is invoked responsive to receiving the user approval.

3. The non-transitory computer readable medium of claim 2, further comprising computer readable code to:
provide a preview of the initial build;
provide a second prompt for user feedback corresponding to the preview of the initial build; and
perform a next coding action of the set of coding actions in accordance with a response to the second prompt.

4. The non-transitory computer readable medium of claim 2, wherein the computer readable code to determine the set of coding actions further comprises computer readable code to:
determine one or more checkpoints in the set of coding actions.

5. The non-transitory computer readable medium of claim 2, wherein the set of coding actions comprises one or more additional user feedback prompts.

6. The non-transitory computer readable medium of claim 5, wherein an agent module iterates through the set of coding actions until any of the one or more additional user feedback prompts are reached.

7. The non-transitory computer readable medium of claim 2, further comprising computer readable code to:
perform a debugging operation on a code segment generated from at least one of the set of coding actions;
determine an additional user prompt for additional user feedback based on a result of the debugging operation; and
present the additional user prompt for user feedback.

8. The non-transitory computer readable medium of claim 1, further comprising computer readable code to:
in response to determining that a stopping criterion is satisfied, deploy a current build of the program code.

9. The non-transitory computer readable medium of claim 1, further comprising compute readable code to:
identify a predefined prompt based on the application parameters; and
fuse the predefined prompt with the natural language code description to obtain,
wherein the language model is invoked using the fused predefined prompt and natural language code description.

10. A method comprising:
determining, based on a natural language code description for an unwritten computer program, application parameters;
identifying one or more predefined development tools for the application parameters from a tool store, wherein the one or more predefined development tools comprises one or more predefined code segments; and
invoking a language model to generate an initial build of program code for the unwritten computer program based on the application parameters and the one or more predefined code segments.

11. The method of claim 10, further comprising:
determining, based on the natural language code description, an intended code generation request;
determining a set of coding actions to generate the unwritten computer program based on the intended code generation request; and
presenting a description of the set of coding actions and a first user prompt for user approval,
wherein the language model is invoked responsive to receiving the user approval.

12. The method of claim 11, further comprising:
providing a preview of the initial build;
providing a second prompt for user feedback corresponding to the preview of the initial build; and
performing a next coding action of the set of coding actions in accordance with a response to the second prompt.

13. The method of claim 11, wherein determining the set of coding actions further comprises:
determining one or more checkpoints in the set of coding actions.

14. The method of claim 11, wherein the set of coding actions comprises one or more additional user feedback prompts.

15. The method of claim 14, wherein an agent module iterates through the set of coding actions until any of the one or more additional user feedback prompts are reached.

16. The method of claim 11, further comprising:
performing a debugging operation on a code segment generated from at least one of the set of coding actions;
determining an additional user prompt for additional user feedback based on a result of the debugging operation; and
presenting the additional user prompt for user feedback.

17. The method of claim 10, further comprising:
identifying a predefined prompt based on the application parameters; and
fusing the predefined prompt with the natural language code description to obtain,
wherein the language model is invoked using the fused predefined prompt and natural language code description.

18. A system comprising:
one or more processors; and
one or more computer readable media comprising computer readable code executable by the one or more processors to:
determine, based on a natural language code description for an unwritten computer program, application parameters;
identify a predefined prompt based on the application parameters; and
fuse the predefined prompt with the natural language code description to obtain,
identify one or more predefined natural language for the application parameters from a tool store, wherein the one or more predefined natural language comprises one or more predefined code segments; and
invoke a language model to generate an initial build of program code for the unwritten computer program using the fused predefined prompt and natural language code description, and the one or more predefined code segments.

19. The system of claim 18, further comprises computer readable code to:
determine, based on the natural language code description, an intended code generation request;
determine a set of coding actions to generate the unwritten computer program based on the intended code generation request; and
present a description of the set of coding actions and a first user prompt for user approval,
wherein the language model is invoked responsive to receiving the user approval.

20. The system of claim 19, further comprising computer readable code to:
provide a preview of the initial build;
provide a second prompt for user feedback corresponding to the preview of the initial build; and
perform a next coding action of the set of coding actions in accordance with a response to the second prompt.
